(19) United States
(12) Patent Application Publication
(10) Pub. No.: US 2021/0297463 A1
(43) Pub. Date: Sep. 23, 2021

(54) Information Real Time Sharing and Mirroring

(71) Applicant: Thiago H Nascimento, DAVIE, FL (US)

(72) Inventor: Thiago H Nascimento, DAVIE, FL (US)

(21) Appl. No.: 16/941,334

(22) Filed: Jul. 28, 2020

Related U.S. Application Data
(60) Provisional application No. 62/993,472, filed on Mar. 23, 2020.

(51) Int. Cl. H04L 29/06

(52) U.S. Cl. CPC H04L 65/40; H04L 65/1069

(57) ABSTRACT

An electronic and or computer application that will run through a device and or widget that allow one or many users from anywhere in the galaxies and or universe to stream, transmit, share, exchange, and mirror data, voice, video data, and other electronic and or non-electronic information and or communication content with each other's device and or widget through the World Wide Web and or through non World Wide Web.

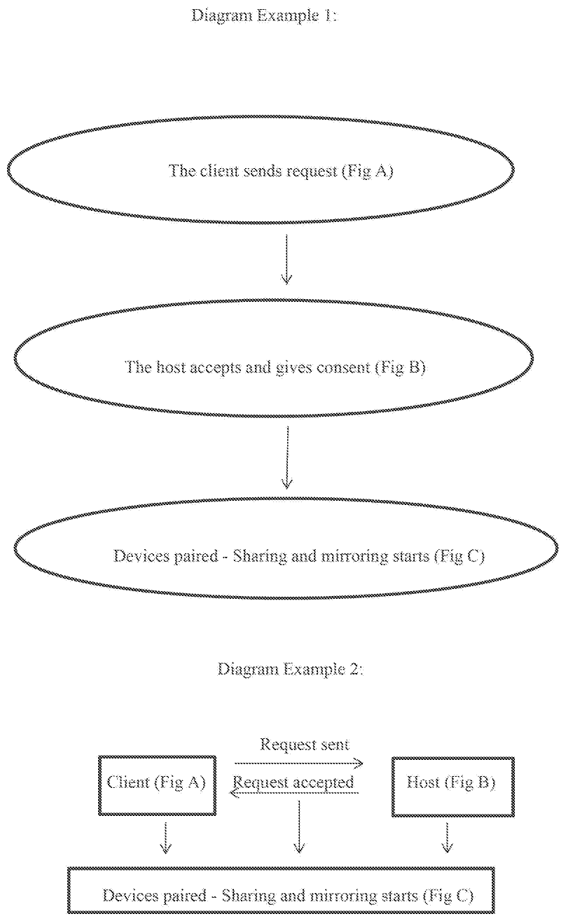

### SPECIFICATION OF THE INVENTION

Information and content share among people have increased worldwide. It is all due to globalization as well as an increase of information and content platforms and devices. Nowadays, there are many options that people can utilize to communicate worldwide. For instance, to name a few, Facetime, Skype, WebEx, and WhatsApp allow people to share video and voice content. In addition, Smart TV System enables people to mirror its content from their phone.

However, as opposed to all of those options available in the market today; my invention will allow people to mirror and share each other's content into their devices and widgets real time. By applying current and instill adapting to future technologies, it enables one device to reproduce and mirror its content of any form into another device or devices held by a third party (one or infinity number of people) and thus acting as sender (client) and receiver (host) hereby named collectively as “The Content Mirroring”.

In addition, client and host may give consent to access partial or full access of its device or widget. The Content Mirroring can be an implied and or explicit method, process, and or system that can be tangible or intangible or other electronic and none electronic exchange method that stream, send, receive, exchange, transmit, mirror, and share information and other communication content with hereby named collectively as “The Community”.

The Community can be a worldwide tangible or intangible and are bounded between “The Content Minoring” whether as a natural person or a formed legal entity (company).

“The community” will be integrated by developing a tangible, intangible, direct or indirect method, system, and or process(s) of exchanging information and other communication content as explained above. A sender (client) will send a request to the receiver (host) to mirror so they can exchange information and communication content once request has been accepted.

Fig A—The sender (client) would like to mirror data, information, and or content from its device into the receiver (host) device. It will send a consent request to the host with or without the interne or other connectivity methods.

Fig B—The receiver (host) will decide to give consent by accepting or not the request from the client to share, stream, and or gain full or partial access to its device and or widget one time or unlimited time in the future as first consented by the host.

Fig C—If the host accepts, it will allow the host and the client feel, smell, see, and or listening the same content played or shared by one to another.

1. For example: (Fig A) if I am listening to a music song and a friend or family member would like to listen to the same music song at the same time then all I have to do is to send a request so he/she can accept (fig B) then allow them to listen to the same song at real time (Fig C). Likewise, (Fig A) if I am watching a movie or other stream video(s) content and a friend or family member would like to watch the same movies at real time then I send them a request and once accepted (Fig B) they will be able to watch the same movie content real time from each other's own device (Fig C).
Hence, not limited to the examples within the drawing paragraph, once the request has been accepted both devices and or widgets will work as a mirror and anything played in one device will be mirrored and or shared to another device fully or partially including but not limited to photos, any type and or method of data, videos, and or voice currently available and instill future systems and methods from a third party application. Another feature of this invention includes that consent request can be sent from one party to another by direct or indirect methods which includes manually sends a request or just having a device and or widget close to each such as iPhone Airdrop or Android Nearby Sharing. Another feature of this invention includes the requirement or none-requirement of internet, Wi-Fi, and or other interne transmittal method. Another feature of this invention includes the amount of access that a client will have into the host device or widget or host into the client that could be partial or full access based on consent. Another feature of this invention includes accessibility from anywhere in the world, galaxies, and universe.
This invention may at its lunch phase or in the future thereafter allow client and host to utilize this application (invention) with partial or full feature(s) described within the patent request and proposal.
